(19) United States
(12) Patent Application Publication
(10) Pub. No.: US 2024/0305133 A1
(43) Pub. Date: Sep. 12, 2024

(54) Resetting Quantum States of Multi-State Devices Via Tunable Energy-Transfer Devices Within Quantum Computing Systems

(71) Applicant: Google LLC, Mountain View, CA (US)

(72) Inventor: Daniel Sank, Goleta, CA (US)

(21) Appl. No.: 18/180,743

(22) Filed: Mar. 8, 2023

(51) Int. Cl. H02J 50/12; G06N 10/20

(52) U.S. Cl. CPC H02J 50/12; G06N 10/20

(57) ABSTRACT

A quantum computing system includes a qubit, a coupler, and a resonator. The qubit has quantum states associated with discretized frequencies. The coupler has a tunable coupler frequency. When the coupler frequency is tuned to a first frequency value in accordance with a frequency of the qubit, a first energy-transfer operation is enabled that transfers a first quantized amount of energy from the first qubit to the coupler such that the qubit is prepared in a first quantum state. The resonator has a resonant frequency. The resonator is enabled to store input energy that is in accordance with its resonant frequency. When the coupler frequency is tuned to a second frequency value in accordance with its resonant frequency, a second energy-transfer operation is initiated that transfers the first quantized amount of energy from the coupler to the resonator. The resonator may dissipate the energy transferred to it.

### FIELD

The present disclosure relates generally to quantum computing and information processing systems, and more particularly to resetting quantum states of multi-state devices (e.g., qubits) via tunable energy-transfer devices (e.g., tunable qubit couplers) within quantum computing systems.

### BACKGROUND

Quantum computing is a computing method that takes advantage of quantum effects, such as superposition of basis states and entanglement to perform certain computations more efficiently than a classical digital computer. In contrast to a digital computer, which stores and manipulates information in the form of bits, e.g., a “1” or “0,” quantum computing systems can manipulate information using quantum bits (“qubits”). A qubit can refer to a quantum device that enables the superposition of multiple states, e.g., data in both the “0” and “1” state, and/or to the superposition of data, itself, in the multiple states. In accordance with conventional terminology, the superposition of a “0” and “1” state in a quantum system may be represented, e.g., as a |0 [symbol] +b|1 [symbol] The “0” and “1” states of a digital computer are analogous to the |0 [symbol] and |1 [symbol] basis states, respectively of a qubit.

### SUMMARY

Aspects and advantages of embodiments of the present disclosure will be set forth in part in the following description, or can be learned from the description, or can be learned through practice of the embodiments.

One example aspect of the present disclosure is directed to a quantum computing system. The quantum computing system includes a first multi-state device, a first tunable device, a first energy-storage device, and a processor device. The first multi-state device is characterized by a set of quantum states that are subdivided into a set of computational states and a set of non-computational states. Each pair of quantum states of the set of quantum states is associated with a separate discretized frequency of a set of discretized frequencies. The first tunable device has a first coupler frequency that is tunable. When the first coupler frequency is tuned to a first frequency value that is in accordance with a first subset of the set of quantized frequencies, a first energy-transfer operation is enabled. The first energy-transfer operation transfers a first quantized amount of energy from the first multi-state device to the first tunable device such that the first multi-state device is prepared in a first computational state of the set of computational states. The first energy-storage device has a first resonant frequency. The first energy-storage device is enabled to at least temporarily store input energy that is in accordance with the first resonant frequency. When the first coupler frequency is tuned to a second frequency value that is in accordance with the first resonant frequency, a second energy-transfer operation is initiated. The second energy-transfer operation transfers the first quantized amount of energy from the first tunable device to the first energy-storage device. The processor device is configured to cause a performance of a set of energy-transfer operations that includes the first energy-transfer operation and the second energy-transfer operation.

Other aspects of the present disclosure are directed to various systems, methods, apparatuses, non-transitory computer-readable media, computer-readable instructions, and computing devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, explain the related principles.

### BRIEF DESCRIPTION OF THE DRAWINGS

Detailed discussion of embodiments directed to one of ordinary skill in the art is set forth in the specification, which refers to the appended figures, in which:

FIG. 1 depicts an example quantum computing system according to example embodiments of the present disclosure;

FIG. 2 provides a schematic view of the quantized states of a qubit device, according to various embodiment;

FIG. 3 illustrates operations of a process for resetting a quantum state of a multi-state device via a tunable energy-transfer device, according to various embodiments; and

FIG. 4 depicts a flow diagram of an example method for resetting quantum states of multi-state devices via tunable energy-transfer devices (e.g., tunable qubit couplers) and energy-storage devices (e.g., resonator devices) within quantum computing systems, according to example embodiments of the present disclosure.

### DETAILED DESCRIPTION

Example aspects of the present disclosure are directed to methods, architectures, and hardware configurations that enable the resetting of quantum states of multi-state devices (e.g., qubits) via tunable energy-transfer devices (e.g., tunable qubit couplers) within quantum computing systems. In quantum computing systems, a qubit has two or more possible “non-superposition” quantum states, where the “non-superposition” states are defined with respect to eigenstates of a particular qubit measurement apparatus (or the eigenstates of a matrix operator that corresponds to the measurement apparatus). Thus, throughout, a non-superposition state (with respect to a measurement apparatus) may be referred to as an eigenstate (of the measurement apparatus). At least two of the possible quantum states are employed as information-carrying states and are thus referred to as computational states of the qubits. A qubit may have more possible non-superposition states that are in addition to its computational states. For instance, the quantum states of a qubit may include non-computational states. Also note that prior to an apparent “collapse” of its wavefunction, which happens when the qubit's wavefunction is entangled with the wavefunction of the measurement apparatus (e.g., a qubit measurement is performed), a qubit may be in any possible “superposition” of its non-superposition states (e.g., defined by a complex-valued amplitude for each non-superposition state subject to an overall normalization constraint and the irrelevancy of any overall phase on the amplitudes).

During a computation in such systems, a qubit may be subject to inadvertently transitioning from a computational state (or a superposition of its computational states) to a non-computational state (or a transition to a superposition of states that includes one or more non-computational states). Transitioning to a non-computational state may result in computational errors, or even destroy the computation. Transitioning to a non-computational state (or a superposition that includes at least one non-computational state) may be referred to as qubit “leakage.” Thus, non-computational quantum states may be referred to as “leakage” states. The operation of returning a qubit from an excited state (e.g., either a computational or non-computational excited state) to the qubit's ground state may be referred to as “resetting” the qubit. Thus, resetting a qubit may include transitioning the qubit's quantum state from a non-computational excited state to the qubit's computational ground state. Resetting a qubit may include preparing the qubit's quantum state to a non-superposition state (e.g., the qubit's ground state).

In many quantum computing systems, the computational states of qubits are constrained to the two lowest quantized energy levels of the qubits, e.g., (|0 [symbol] , |1 [symbol] ) in the standard basis. In such systems, if a qubit is subject to additional energy levels, these higher energy levels would be non-computational (or leakage) states. The discussion throughout is directed towards the assumption of bi-state qubits, where (|0 [symbol] , |1 [symbol] ) (and superpositions thereof) are the only computational states of a single qubit. Although the embodiments are not so limited, and the embodiments may be generalized to include more than two computational non-superposition states for a single qubit.

Also in many quantum computing systems, the qubits are implemented by a transmon superconducting circuit (e.g., a transmon qubit). The quantized energy levels of a transmon qubit can be modeled approximately as a quantum harmonic oscillator (QHO) system, with many possible quantum states beyond the QHO's ground state (e.g., |0 [symbol] ) and the QHO's first excited state (e.g., |1 [symbol] ), such as but not limited to: |2 [symbol] , |3 [symbol] , |4 [symbol] , and the like. Thus, transmon qubits may be subject to several (or perhaps an infinite number of) non-computational (or leakage) states. The discussion throughout is directed towards the assumption of transmon qubits with two possible computational states (e.g., (|0 [symbol] , |1 [symbol] )) and several possible non-computational states (e.g., any excited stated beyond |1 [symbol] ). Although the embodiments are not so limited, and the embodiments may be generalized to include non-transmon qubits (that are subject to leakage states) and/or qubits where the computational states are not limited to (|0 [symbol] , |1 [symbol] ).

The quantum states of qubits may be delicate and subject to decoherence or other computationally destructive mechanisms. Thus, quantum error correction (QEC) is a critical component of many quantum computing systems. Leakage states violate the assumptions of many QEC paradigms (e.g., surface codes). Furthermore, QEC paradigms may require frequent measurements (or readings) of ancilla qubits (e.g., syndrome measurements). As discussed below, in some conventional arrangements, such frequent qubit measurements tend to create leakage in the qubits. As such, resetting qubits (e.g., after a qubit measurement as required by a QEC cycle) is an important function in many quantum computing systems that implement QEC. The embodiments are directed towards providing resets of qubits without generating the leakage associated with conventional methods and configurations.

In some methods and configurations, a resonator device (or circuit) is employed to measure (or read) a qubit, as required by QEC. Furthermore, the resonator device is employed to reset the qubit. A resonator device (or circuit) may be a device that resonates (and thus stores energy) at a particular frequency (or a relatively narrow band of resonant frequencies). Thus, a resonator (e.g., a resonator device and/or circuit) may be employed to transfer energy away from a device (e.g., a qubit). Once transferred away from the device and to the resonator, the resonator may dissipate the energy to an energy sink or another apparatus (e.g., a measurement apparatus). To transfer energy away from a device (e.g., a qubit), the resonator's resonant frequency (or resonant-frequency band) should be in accordance with the frequencies of the energy to be transferred (e.g., the delta between the qubit's energy states). Furthermore, a resonator device may not be tunable, and its resonant frequencies are determined by physical characteristics of the resonator (e.g., the length of a distributed waveguide resonator or cavity (or the circuit's LC constant)).

In some arrangements, the resetting/measuring resonator is manufactured such that its resonant frequencies are in accordance with the energy differences between the qubit's possible state transitions (e.g., the delta between the QHO's energy levels). Furthermore, some transmon qubits may only be tuned downward, and not upward. For various reasons, the readout (or measurement) of a qubit via a resonator with a resonant frequency lower than the qubit's frequency tends to generate significant leakage. Thus, some arrangements tend to generate significant amounts of leakage in qubits. As noted above, this leakage tends to degrade the performance of many QEC methods (e.g., surface codes), as well as other computational characteristics of a quantum computing system.

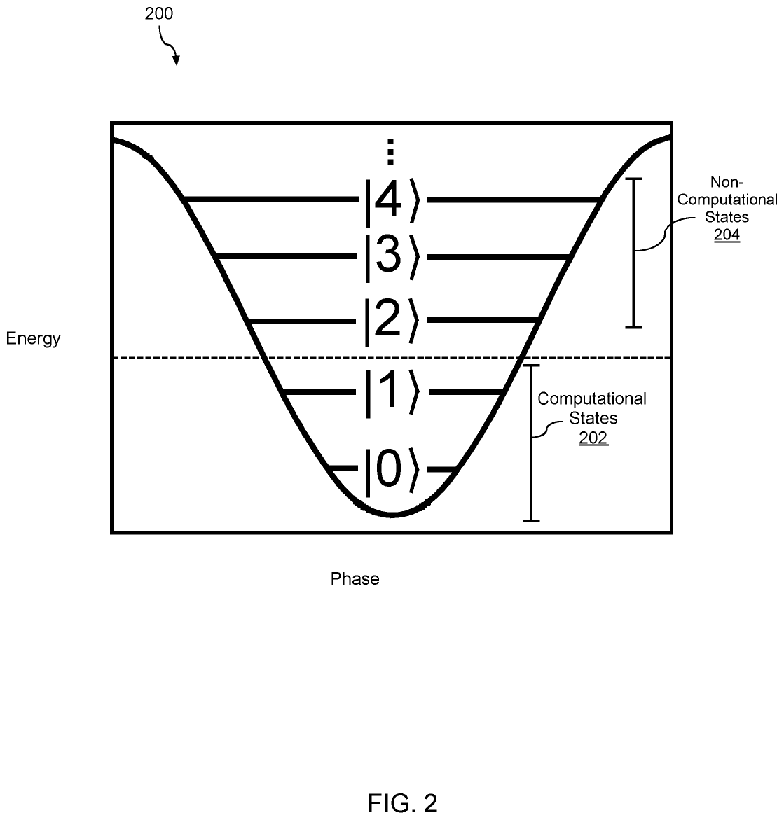

Examples of the present disclosure overcome these (and other) limitations by employing a resonator with resonant frequencies that are significantly greater than the qubit's frequencies. For instance, in the embodiments, the resonator device may have a resonant frequency that is approximately 1 GHz greater than the qubit's frequency. A qubit may be readout (e.g., to perform a QEC cycle) and needs to be reset (e.g., returned to its ground state) for the next QEC cycle. To reset a qubit, a tunable energy-transfer device (e.g., a qubit coupler) is tuned to approximately the qubit's frequency. That is, the tunable energy-transfer device is tuned to be on-resonance with the qubit. In some embodiments, the tunable energy-transfer device is tuned to a frequency that is greater or lesser than the qubit's frequency. The qubit may be reset to its ground state (e.g., |0 [symbol] ) from any computational excited state (e.g., |1 [symbol] ) or non-computational excited state (e.g., |2 [symbol] ). Similar to qubits, a qubit coupler has quantized energy levels (e.g., see FIG. 2). The following notation may be adopted |Q, C [symbol] to describe the qubit-qubit coupler state, where Q is a non-negative integer indicating the qubit's quantum state and C is another nom-negative integer indicating the qubit coupler's quantum state. The frequencies of the qubit and the qubit coupler scale with the respective quantum state. To reset a qubit from its second excited (e.g., non-computational) state to its ground state, the following sequence of energy transitions may be performed (e.g., by tuning the frequency of the qubit coupler): |2,0 [symbol] →|1,1 [symbol] →|→0,2 [symbol] . In the first step (e.g., |2,0 [symbol] →|1,1 [symbol] ) a first quantum of energy is transferred from the qubit to the qubit coupler. In the second step (e.g., |1,1 [symbol] →|0,2 [symbol] ) a second quanta of energy is transferred from the qubit to the qubit coupler. By tuning the coupler's frequency to the resonator, both quanta of energy may be transferred from the coupler to the resonator. The resonator may then dissipate the two quanta of energy in a manner that does not decohere the qubit or the qubit coupler. This energy-transfer process may be generalized such that the state transition |n,0 [symbol] →|0,n [symbol] for any positive integer n may be performed, and the n quanta of energy may be transferred to and dissipated by the resonator. Note that in some embodiments that provide multi-level resets (e.g., |2,0 [symbol] →|1,1 [symbol] →|0,2 [symbol] ), the coupler may be re-tuned to transfer a single quantum of energy to the resonator between each level transition. For instance, after performing the transition, |2,0 [symbol] →|1,1 [symbol] , the coupler may be tuned to dump the quantum of energy to the resonator before performing the transition |1,1 [symbol] →|0,2 [symbol] . In other embodiments that provide multi-level resets, the coupler may store multiple quanta before being tuned to transfer the multiple quanta to the resonator.

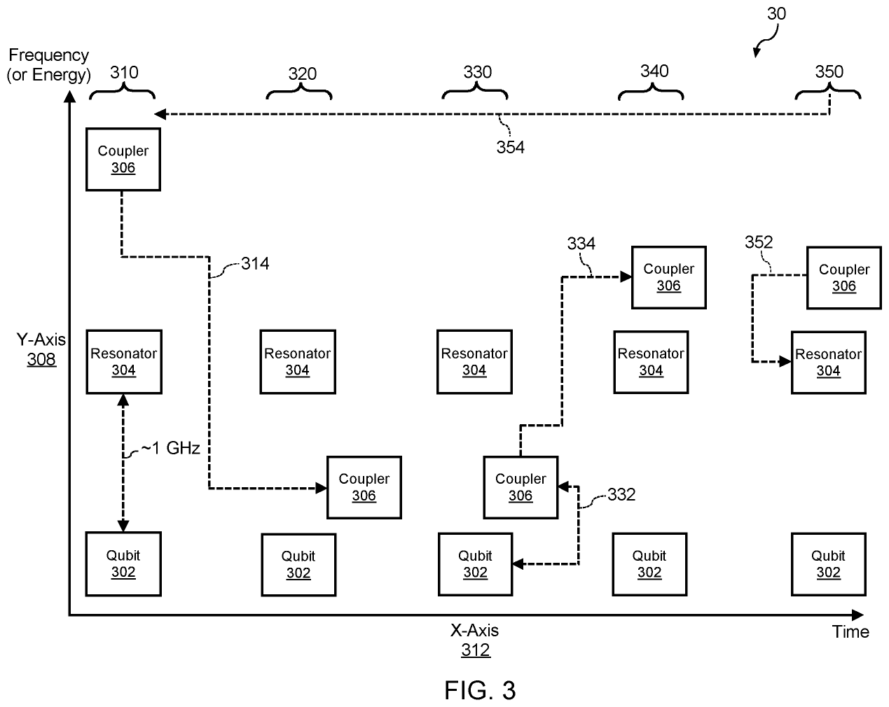

As highlighted above and discussed in further detail in conjunction with at least FIG. 3, a quantum-state swap operation may be performed between the tunable energy-transfer device and the qubit. The swap operation may transfer quantized energy from the qubit to the tunable energy-transfer device, resetting the qubit to its ground state (e.g., |0 [symbol] ). The energy transferred from the qubit's excited state is temporally stored in the energy-transfer device. The energized tunable energy-transfer device is then re-tuned to be on resonance with the resonator. In some embodiments, the tunable energy-transfer device is tuned to a frequency that is greater or lesser than the resonator's resonant frequency. The energy (from the qubit's excited state) that is stored in the energy-transfer device is then transferred (or dumped) to the relatively high-frequency resonator. Thus, the tunable energy-transfer device may be an “energy shuttle” that shuttles energy (e.g., on the form of discrete photons) from a relatively low-frequency qubit to a relatively high-frequency resonator, via the tuning and re-tuning of the energy transfer device. Thus, a qubit coupler may be employed as a “photon shuttle” between the qubit and the resonator.

In some embodiments, a quantum computing system may include a set of qubits and a set of qubit couplers. Each qubit of the set of qubits is coupled to at least one other qubit of the set of qubits via at least one qubit coupler of the set of couplers. Note that each qubit of the set of qubits and each coupler of the set of couplers may be implemented by a superconducting transmon qubit. A set of transmon qubits may be arranged in a 2D array, e.g. a 2D grid of transmon qubits that alternate between transmon qubits operated as a multi-state qubits and qubits operated as a qubit coupler (e.g., a checkerboard pattern of qubits and qubit couplers). Two qubits in the 2D array (separated by another qubit) may be coupled via the separating qubit operated as a coupler between the two qubits. To avoid potential confusion in the following discussion, even though a coupler is implemented by a qubit, when it is operated as a coupler, the coupling qubit may be referred to as a qubit coupler (or simply as a coupler).

Each qubit of the set of qubits is coupled to at least one resonator of a set of resonators for readout and resetting purposes. Also, each coupler of the set of couplers is also coupled to at least one resonator of the set of resonators. In some embodiments, a qubit of the set of qubits and a corresponding coupler of the set of couplers are coupled to the same resonator of the set of resonators. Each coupler of the set of couplers may be operated in at least two modes: as a quantum logic gate between two consecutive (or neighboring) qubits of the set or as a tunable energy-transfer device (as discussed above). Thus, a particular qubit of the set of qubits, the corresponding coupler of the set of couplers, and the corresponding resonator of the set of resonators may be conceptualized as a (qubit, coupler, resonator) triplet. As noted above, the resonant frequencies of the resonators may be significantly greater (e.g., approximately 1 GHz greater) than the qubit frequencies.

The couplers may be operated to implement quantum logic gates, except when resetting the corresponding qubit (e.g., after a readout cycle of the QEC). At a qubit's readout (via the corresponding resonator), the corresponding coupler is operated as a tunable energy-transfer device (e.g., a photon shuttle) and is tuned to approximately the qubit's frequency (e.g., the coupler is tuned to be on-resonance with the qubit). A quantum state swap operation is performed between the qubit and corresponding coupler. This swap operation transfers the qubits energy (and thus its quantum state) to the coupler. The coupler is then re-tuned to be approximately on-resonance with the higher-frequency corresponding resonator, which allows the transferred energy of the qubit to be dumped to the corresponding resonator. Thus, higher frequency resonators may be employed, which decreases leakage, while still being able to reset a qubit after a readout cycle.

Aspects of the present disclosure provide a number of technical effects and benefits. For instance, the resonant frequency of a resonator may be significantly greater than the qubit's frequency, which decreases leakage when reading the qubit (e.g., during a QEC cycle). To reset the qubit, rather than the resonator being employed to reset the qubit (e.g., which is typical in conventional methods but may not be employable when the resonant frequency is greater than the qubit's frequency), a tunable qubit coupler is employed to “shuttle” or transfer energy away from the qubit.

As used herein, the term “about” or “approximately” in conjunction with a numerical value refers to within 10% of the numerical value.

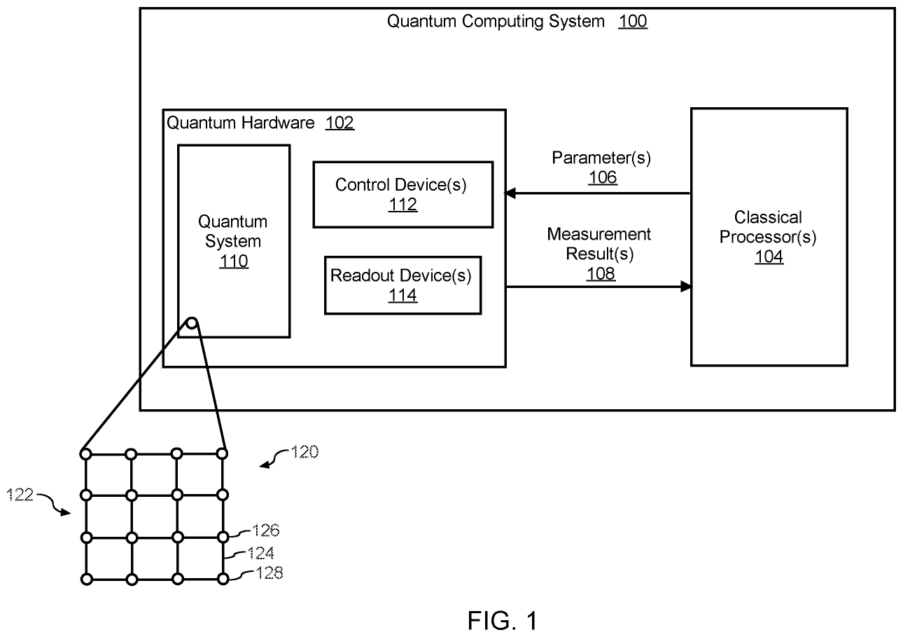

FIG. 1 depicts an example quantum computing system 100. The system 100 is an example of a system of one or more classical computers and/or quantum computing devices in one or more locations, in which the systems, components, and techniques described below can be implemented. Those of ordinary skill in the art, using the disclosures provided herein, will understand that other quantum computing devices or systems can be used without deviating from the scope of the present disclosure.

The system 100 includes quantum hardware 102 in data communication with one or more classical processors 104. The classical processors 104 can be configured to execute computer-readable instructions stored in one or more memory devices to perform operations, such as any of the operations described herein. The quantum hardware 102 includes components for performing quantum computation. For example, the quantum hardware 102 includes a quantum system 110, control device(s) 112, and readout device(s) 114 (e.g., readout resonator(s)). The quantum system 110 can include one or more multi-level quantum subsystems, such as a register of qubits (e.g., qubits 120). In some implementations, the multi-level quantum subsystems can include superconducting qubits, such as flux qubits, charge qubits, transmon qubits, gmon qubits, spin-based qubits, and the like.

The type of multi-level quantum subsystems that the system 100 utilizes may vary. For example, in some cases it may be convenient to include one or more readout device(s) 114 attached to one or more superconducting qubits, e.g., transmon, flux, gmon, xmon, or other qubits. In other cases, ion traps, photonic devices or superconducting cavities (e.g., with which states may be prepared without requiring qubits) may be used. Further examples of realizations of multi-level quantum subsystems include fluxmon qubits, silicon quantum dots or phosphorus impurity qubits.

Quantum circuits may be constructed and applied to the register of qubits included in the quantum system 110 via multiple control lines that are coupled to one or more control devices 112. Example control devices 112 that operate on the register of qubits can be used to implement quantum gates or quantum circuits having a plurality of quantum gates, e.g., Pauli gates, Hadamard gates, controlled-NOT (CNOT) gates, controlled-phase gates, T gates, multi-qubit quantum gates, coupler quantum gates, etc. The one or more control devices 112 may be configured to operate on the quantum system 110 through one or more respective control parameters (e.g., one or more physical control parameters). For example, in some implementations, the multi-level quantum subsystems may be superconducting qubits and the control devices 112 may be configured to provide control pulses to control lines to generate magnetic fields to adjust the frequency of the qubits.

The quantum hardware 102 may further include readout devices 114 (e.g., readout resonators). Measurement results 108 obtained via measurement devices may be provided to the classical processors 104 for processing and analyzing. In some implementations, the quantum hardware 102 may include a quantum circuit and the control device(s) 112 and readout devices(s) 114 may implement one or more quantum logic gates that operate on the quantum system 102 through physical control parameters (e.g., microwave pulses) that are sent through wires included in the quantum hardware 102. Further examples of control devices include arbitrary waveform generators, wherein a DAC (digital to analog converter) creates the signal.

The readout device(s) 114 may be configured to perform quantum measurements on the quantum system 110 and send measurement results 108 to the classical processors 104. In addition, the quantum hardware 102 may be configured to receive data specifying physical control qubit parameter values 106 from the classical processors 104. The quantum hardware 102 may use the received physical control qubit parameter values 106 to update the action of the control device(s) 112 and readout devices(s) 114 on the quantum system 110. For example, the quantum hardware 102 may receive data specifying new values representing voltage strengths of one or more DACs included in the control devices 112 and may update the action of the DACs on the quantum system 110 accordingly. The classical processors 104 may be configured to initialize the quantum system 110 in an initial quantum state, e.g., by sending data to the quantum hardware 102 specifying an initial set of parameters 106.

In some implementations, the readout device(s) 114 can take advantage of a difference in the impedance for the |0 [symbol] and |1 [symbol] states of an element of the quantum system, such as a qubit, to measure the state of the element (e.g., the qubit). For example, the resonance frequency of a readout resonator can take on different values when a qubit is in the state |0 [symbol] or the state |1 [symbol] , due to the nonlinearity of the qubit. Therefore, a microwave pulse reflected from the readout device 114 carries an amplitude and phase shift that depend on the qubit state. In some implementations, a Purcell filter can be used in conjunction with the readout device(s) 114 to impede microwave propagation at the qubit frequency.

In some embodiments, the quantum system 110 can include a plurality of qubits 120 arranged, for instance, in a two-dimensional grid 122. For clarity, the two-dimensional grid 122 depicted in FIG. 1 includes 4×4 qubits, however in some implementations the system 110 may include a smaller or a larger number of qubits. In some embodiments, the multiple qubits 120 can interact with each other through multiple qubit couplers, e.g., qubit coupler 124. The qubit couplers can define nearest neighbor interactions between the multiple qubits 120. In some implementations, the strengths of the multiple qubit couplers are tunable parameters. In some cases, the multiple qubit couplers included in the quantum computing system 100 may be couplers with a fixed coupling strength.

In some implementations, the multiple qubits 120 may include data qubits, such as qubit 126 and measurement qubits, such as qubit t. A data qubit is a qubit that participates in a computation being performed by the system 100. A measurement qubit is a qubit that may be used to determine an outcome of a computation performed by the data qubit. That is, during a computation an unknown state of the data qubit is transferred to the measurement qubit using a suitable physical operation and measured via a suitable measurement operation performed on the measurement qubit.

In some implementations, each qubit in the multiple qubits 120 can be operated using respective operating frequencies, such as an idling frequency and/or an interaction frequency and/or readout frequency and/or reset frequency. The operating frequencies can vary from qubit to qubit. For instance, each qubit may idle at a different operating frequency. The operating frequencies for the qubits 120 can be chosen before a computation is performed.

FIG. 1 depicts one example quantum computing system that can be used to implement the methods and operations according to example aspects of the present disclosure. Other quantum computing systems can be used without deviating from the scope of the present disclosure.

FIG. 2 provides a schematic view of the quantized states of a qubit device, according to various embodiment. As noted throughout, a qubit device may be a transmon qubit. The quantized energy levels of a transmon qubit can be modeled as approximately a quantum harmonic oscillator (QHO) system. FIG. 2 provides an energy-level diagram 200 that indicates the energy levels (e.g., |0 [symbol] , |1 [symbol] , |2 [symbol] , 3 [symbol] , |4 [symbol] , . . . ) of a transmon qubit. The x-axis represents the phase of the transmon qubit, while the y-axis represents the energy levels of the quantized states of the transmon qubit. The energy levels of a transmon qubit may be eigenstates associated with a qubit measuring apparatus of a quantum computing system (e.g., quantum computing system 100 of FIG. 1). The set of eigenstates may be divided into two disjoint sets: a set of computational states 202 and a set of non-computational states 204. In the non-limiting embodiment of FIG. 2, the set of computational states 202 includes the two eigenstates. The set of non-computational states includes all of the higher energy levels. (|2 [symbol] , 3 [symbol] , |4 [symbol] , . . . ).

FIG. 3 illustrates operations of a process 300 for resetting a quantum state of a multi-state device via a tunable energy-transfer device, according to various embodiments. Process 300 may be implemented by a quantum computing system (e.g., quantum computing system 100 of FIG. 1) that includes a qubit 302, a resonator 304, and a tunable (or adjustable) coupler 306. Although not explicitly shown in FIG. 3, the quantum computing system may additionally include a processor device, a qubit measurement device (or apparatus), a first electrical coupling, and a second electrical coupling. The x-axis 312 of FIG. 3 represents increasing time. The y-axis 308 of FIG. 3 represents increase energy (or frequency).

Qubit 302 may be referred to as a multi-state device. The coupler 306 may be a qubit coupler and may be referred to as an energy-transfer device and/or as a tunable device (e.g., a tunable energy-transfer device). The resonator 304 may be referred to as an energy-storage device. Although not explicitly shown in FIG. 3. The qubit 302 may have a qubit frequency that is associated with one or more of its quantum states (or transitions between quantum states). The resonator 304 may have a resonant frequency. The coupler 306 may have a tunable coupler frequency. As shown by the y-axis 308, the resonant frequency of the resonator may be greater than the qubit frequency of the qubit 302. In some embodiments, the resonator frequency may be approximately 1 GHz greater than the qubit frequency. The tunable frequency of the coupler 302 may be tuned (or adjusted) to be anywhere from greater than the resonant frequency of the resonator 304 to be at least approximately equivalent to the qubit frequency of the qubit 302.

The first electrical coupling may be configured and arranged to electrically couple the qubit 302 to the coupler 306, such that energy may be transferred from the qubit 302 to the coupler 306 in an energy-transfer operation, when the tunable coupler frequency is at least approximately equivalent to the qubit frequency. The second electrical coupling may be configured and arranged to electrically couple the resonator 304 to the coupler 306, such that energy may be transferred from the coupler 306 to the resonator 304 in another energy-transfer operation, when the tunable coupler frequency is at least approximately equivalent to the resonant frequency of the resonator 304. The processor device is configured to perform the operations of process 300.

During the first operation 310 of process 300, the coupler frequency of the coupler 306 may be greater than the resonant frequency of the resonator 304, which may be greater than the qubit frequency of the qubit 302. At the second operation 320 of process 300, the coupler frequency may be down tuned to be at least approximately equivalent to the qubit frequency, as indicated by the hashed arrow 314. In the third operation 330 of process 300, a first energy-transfer operation (as indicated by hashed arrow 332) may be initiated over the first electrical coupling. The first energy-transfer operation may be a quantum swap operation. In the first energy-transfer operation, a first quantized amount of energy may be transferred from the qubit 302 to the coupler 306. After the energy transfer from the qubit 302 to the coupler 306, the qubit may be reset in one of its computational non-superposition states (e.g., its ground state). In the fourth operation 340 of process 300, the resonant frequency of the coupler 306 may be up-tuned (as indicated by the hashed arrow 334) so that the resonant frequency is approximately equivalent to the resonant frequency of the resonator 304. During the fifth operation 350 of process, a second-energy transfer operation is performed over the second electrical coupling. In the second energy-transfer operation, the energy that was transferred from the qubit 302 to the coupler 306 may be transferred from the coupler 306 to the resonator 304 over the second electrical coupling. The resonator 304 may dissipate the transferred energy via other means. The hashed arrow 354 indicates that process 300 may be returned to the first operation via up-tuning the coupler frequency of the coupler 306. When not actively participating in process 300, the coupler 306 may couple the qubit 302 with another qubit of the quantum computing system. In some embodiments, the coupler 306 may participate in the realization of a quantum logic gate between the qubit 302 and the other qubit.

As noted above, the energy-transfer operations of FIG. 3 may be performed to reset the qubit 302 to its ground state |0 [symbol] ) (e.g.,) from any excited state (e.g., |n [symbol] ) where n is any positive integer. Similar to qubit 302, the qubit coupler 306 has quantized energy levels (e.g., see FIG. 2). The following notation may be adopted |Q,C [symbol] to describe the qubit-qubit coupler state, where Q is a non-negative integer indicating the qubit's 302 quantum state and C is another non-negative integer indicating the coupler's 306 quantum state. To reset the qubit 302 from its second excited (e.g., non-computational) state to its ground state, the following sequence of energy transitions may be performed (e.g., by tuning the frequency of the coupler 306): |2,0 [symbol] →|1,1 [symbol] →|0,2 [symbol] . In the first step (e.g., |2,0 [symbol] →|1,1 [symbol] ) a first quantum of energy is transferred from the qubit 302 to the coupler 306. In the second step (e.g., |1,1 [symbol] →|0,2 [symbol] ) a second quantum of energy is transferred from the qubit 302 to the coupler 306. By tuning the coupler's 306 frequency to the frequency of the resonator 304, both quanta of energy may be transferred from the coupler 306 to the resonator 304. The resonator 304 may then dissipate the two quanta of energy in a manner that does not decohere the qubit 302 or the coupler 306. This energy-transfer process may be generalized such that the state transition |n,0 [symbol] →|0,n [symbol] ) for any positive integer n may be performed, and the n quanta of energy may be transferred to and dissipated by the resonator 304. Note that in some embodiments that provide multi-level resets (e.g., |2,0 [symbol] →|1,1 [symbol] →|0,2 [symbol] , ), the coupler 306 may be re-tuned to transfer a single quantum of energy to the resonator 304 between each level transition. For instance, after performing the transition, |2,0 [symbol] →|1,1 [symbol] , the coupler 306 may be tuned to dump the quantum of energy to the resonator 304 before performing the transition |1,1 [symbol] →|0,2 [symbol] . In other embodiments that provide multi-level resets, the coupler 306 may store multiple quanta before being tuned to transfer the multiple quanta to the resonator.

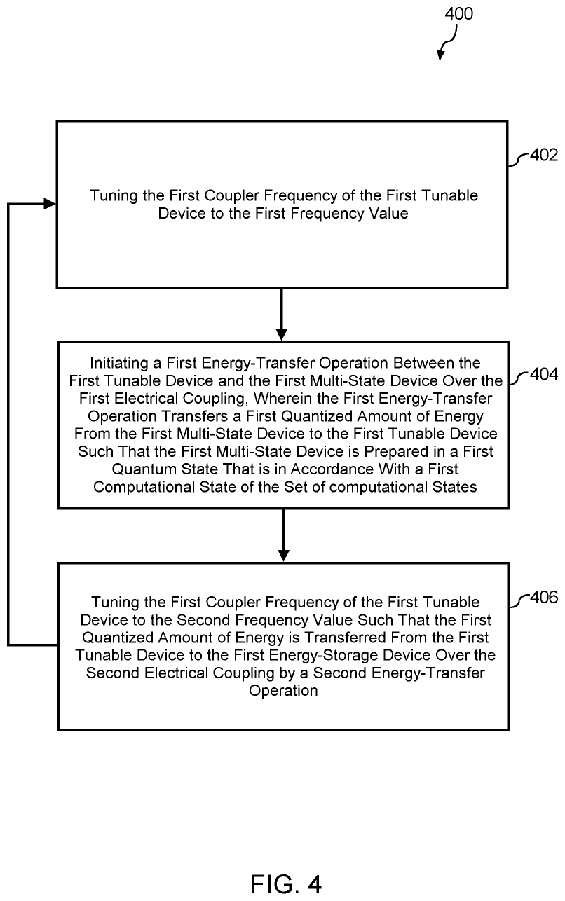

FIG. 4 depicts a flow diagram of an example method 400 for resetting quantum states of multi-state devices (e.g., qubits) via tunable energy-transfer devices (e.g., tunable qubit couplers) and energy-storage devices (e.g., resonator devices) within quantum computing systems, according to example embodiments of the present disclosure. Portions of method 400 may be performed by quantum computing systems, such as but not limited to quantum computing system 100 of FIG. 1. The quantum computing system may include a measurement device, a first multi-state device (e.g., qubit 302 of FIG. 3), a first tunable device (e.g., coupler 306 of FIG. 3), and a first energy-storage device (e.g., resonator 304 of FIG. 3). The first multi-state device may be characterized by a set of eigenstates associated with the measurement device. The set of eigenstates may be subdivided into a set of computational states (e.g., computational states 202 of FIG. 2) and a set of non-computational states (e.g., non-computational states 204 of FIG. 2). Each eigenstate of the set of eigenstates may be associated with a separate quantized frequency of a set of quantized frequencies (e.g., see energy-level diagram 200 of FIG. 2). The first energy-storage device may have a first resonant frequency and be enabled to at least temporarily store input energy that is in accordance with the first resonant frequency. The quantum computing system may additionally include a first electrical coupling. The first electrical coupling may electrically couple the first multi-state device and the first tunable device when the first coupler frequency is a first frequency value that is in accordance with a first subset of the set of quantized frequencies. The quantum computing system may also include a second electrical coupling. The second electrical coupling may electrically couple the first tunable device and the first energy-storage device when first coupler frequency of the first tunable device is a second frequency value that is in accordance with a first resonant frequency of the first energy-storage device. A processor device of the quantum computing system may be enabled to perform at least a portion of the blocks of method 400.

Method 400 begins at block 402, where the first coupler frequency of the first tunable device is tuned to the first frequency value. At block 404, a first energy-transfer operation between the first tunable device and the first multi-state device may be initiated. The first energy-transfer operation may occur over the first electrical coupling. The first energy-transfer operation may transfer a first quantized amount of energy from the first multi-state device to the first tunable device. The first energy-transfer operation may prepare a first quantum state of the first multi-state device in a first quantum state. The first quantum state of the first multi-state device may be in accordance with a first computational state of the set of computational states. At block 406, the first coupler frequency of the first tunable device is tuned to the second frequency value. By tuning the first coupler frequency of the first tunable device to the second frequency value, a second energy-transfer operation may be initialized and/or performed. During the second energy-transfer operation, at least the first quantized amount of energy may be transferred from the first tunable device to the first energy-storage device over the second electrical coupling. Method 400 may return to block 402 to reset the first mutli-state device again.

In some embodiments, the first multi-state device is a first qubit (e.g., qubit 302 of FIG. 3), the first tunable device is a first qubit coupler (e.g., coupler 306 of FIG. 3), and the first energy-storage device is a first resonator device (e.g., resonator 304 of FIG. 3). The first frequency value is a first qubit frequency that is in accordance with the set of computational states. The first resonant frequency of the first resonator device may be significantly greater than the first qubit frequency. For example, the first resonant frequency of the first resonator device may be approximately 1 GHz greater than the first qubit frequency (e.g., see FIG. 2). The first qubit may be implemented by a first transmon qubit. The first qubit coupler may be implemented by a second transmon qubit. The first coupler frequency of the first qubit coupler may be a third frequency value (e.g., see operation 310 of FIG. 3). The thirst frequency value may result in the first qubit coupler electrical coupling the first qubit to a second qubit of the quantum computing system by a third electrical coupling. When this occurs, the third electrical coupling may be employed to do a quantum logic gate operation (e.g., an fSim gate operation) for the first qubit and the second qubit. The first quantum state of the first qubit may be a ground state such that the first energy-transfer operation resets the first qubit to the ground state. Tuning the first coupler frequency of the first qubit coupler may be in response to performing a measurement of the first qubit via the measurement apparatus. The first energy-transfer operation may result in transitioning the first multi-state device from a non-computational state to the first computational state of the set of computational states. The first computational state of the set of computational states may be an eigenstate (e.g., non-superposition) of the measurement device. The non-superposition eigenstate of the measurement device may be a ground state for the first multi-state device.

Implementations of the digital, classical, and/or quantum subject matter and the digital functional operations and quantum operations described in this specification can be implemented in digital electronic circuitry, suitable quantum circuitry or, more generally, quantum computational systems, in tangibly-implemented digital and/or quantum computer software or firmware, in digital and/or quantum computer hardware, including the structures disclosed in this specification and their structural equivalents, or in combinations of one or more of them. The term “quantum computing systems” may include, but is not limited to, quantum computers/computing systems, quantum information processing systems, quantum cryptography systems, or quantum simulators.

Implementations of the digital, classical, and/or quantum subject matter and the digital functional operations and quantum operations described in this specification can be implemented in digital electronic circuitry, suitable quantum circuitry or, more generally, quantum computational systems, in tangibly-implemented digital and/or quantum computer software or firmware, in digital and/or quantum computer hardware, including the structures disclosed in this specification and their structural equivalents, or in combinations of one or more of them. The term “quantum computing systems” may include, but is not limited to, quantum computers/computing systems, quantum information processing systems, quantum cryptography systems, or quantum simulators.

Implementations of the digital and/or quantum subject matter described in this specification can be implemented as one or more digital and/or quantum computer programs, i.e., one or more modules of digital and/or quantum computer program instructions encoded on a tangible non-transitory storage medium for execution by, or to control the operation of, data processing apparatus. The digital and/or quantum computer storage medium can be a machine-readable storage device, a machine-readable storage substrate, a random or serial access memory device, one or more qubits/qubit structures, or a combination of one or more of them. Alternatively or in addition, the program instructions can be encoded on an artificially-generated propagated signal that is capable of encoding digital and/or quantum information (e.g., a machine-generated electrical, optical, or electromagnetic signal) that is generated to encode digital and/or quantum information for transmission to suitable receiver apparatus for execution by a data processing apparatus.

The terms quantum information and quantum data refer to information or data that is carried by, held, or stored in quantum systems, where the smallest non-trivial system is a qubit, i.e., a system that defines the unit of quantum information. It is understood that the term “qubit” encompasses all quantum systems that may be suitably approximated as a two-level system in the corresponding context. Such quantum systems may include multi-level systems, e.g., with two or more levels. By way of example, such systems can include atoms, electrons, photons, ions or superconducting qubits. In many implementations the computational basis states are identified with the ground and first excited states, however it is understood that other setups where the computational states are identified with higher level excited states (e.g., qubits) are possible.

The term “data processing apparatus” refers to digital and/or quantum data processing hardware and encompasses all kinds of apparatus, devices, and machines for processing digital and/or quantum data, including by way of example a programmable digital processor, a programmable quantum processor, a digital computer, a quantum computer, or multiple digital and quantum processors or computers, and combinations thereof. The apparatus can also be, or further include, special purpose logic circuitry, e.g., an FPGA (field programmable gate array), or an ASIC (application-specific integrated circuit), or a quantum simulator, i.e., a quantum data processing apparatus that is designed to simulate or produce information about a specific quantum system. In particular, a quantum simulator is a special purpose quantum computer that does not have the capability to perform universal quantum computation. The apparatus can optionally include, in addition to hardware, code that creates an execution environment for digital and/or quantum computer programs, e.g., code that constitutes processor firmware, a protocol stack, a database management system, an operating system, or a combination of one or more of them.

A digital or classical computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a digital computing environment. A quantum computer program, which may also be referred to or described as a program, software, a software application, a module, a software module, a script, or code, can be written in any form of programming language, including compiled or interpreted languages, or declarative or procedural languages, and translated into a suitable quantum programming language, or can be written in a quantum programming language, e.g., QCL, Quipper, Cirq, etc..

A digital and/or quantum computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A digital and/or quantum computer program can be deployed to be executed on one digital or one quantum computer or on multiple digital and/or quantum computers that are located at one site or distributed across multiple sites and interconnected by a digital and/or quantum data communication network. A quantum data communication network is understood to be a network that may transmit quantum data using quantum systems, e.g. qubits. Generally, a digital data communication network cannot transmit quantum data, however a quantum data communication network may transmit both quantum data and digital data.

The processes and logic flows described in this specification can be performed by one or more programmable digital and/or quantum computers, operating with one or more digital and/or quantum processors, as appropriate, executing one or more digital and/or quantum computer programs to perform functions by operating on input digital and quantum data and generating output. The processes and logic flows can also be performed by, and apparatus can also be implemented as, special purpose logic circuitry, e.g., an FPGA or an ASIC, or a quantum simulator, or by a combination of special purpose logic circuitry or quantum simulators and one or more programmed digital and/or quantum computers.

For a system of one or more digital and/or quantum computers or processors to be “configured to” or “operable to” perform particular operations or actions means that the system has installed on it software, firmware, hardware, or a combination of them that in operation cause the system to perform the operations or actions. For one or more digital and/or quantum computer programs to be configured to perform particular operations or actions means that the one or more programs include instructions that, when executed by digital and/or quantum data processing apparatus, cause the apparatus to perform the operations or actions. A quantum computer may receive instructions from a digital computer that, when executed by the quantum computing apparatus, cause the apparatus to perform the operations or actions.

Digital and/or quantum computers suitable for the execution of a digital and/or quantum computer program can be based on general or special purpose digital and/or quantum microprocessors or both, or any other kind of central digital and/or quantum processing unit. Generally, a central digital and/or quantum processing unit will receive instructions and digital and/or quantum data from a read-only memory, or a random access memory, or quantum systems suitable for transmitting quantum data, e.g. photons, or combinations thereof.

Some example elements of a digital and/or quantum computer are a central processing unit for performing or executing instructions and one or more memory devices for storing instructions and digital and/or quantum data. The central processing unit and the memory can be supplemented by, or incorporated in, special purpose logic circuitry or quantum simulators. Generally, a digital and/or quantum computer will also include, or be operatively coupled to receive digital and/or quantum data from or transfer digital and/or quantum data to, or both, one or more mass storage devices for storing digital and/or quantum data, e.g., magnetic, magneto-optical disks, or optical disks, or quantum systems suitable for storing quantum information. However, a digital and/or quantum computer need not have such devices.

Digital and/or quantum computer-readable media suitable for storing digital and/or quantum computer program instructions and digital and/or quantum data include all forms of non-volatile digital and/or quantum memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks; and quantum systems, e.g., trapped atoms or electrons. It is understood that quantum memories are devices that can store quantum data for a long time with high fidelity and efficiency, e.g., light-matter interfaces where light is used for transmission and matter for storing and preserving the quantum features of quantum data such as superposition or quantum coherence.

Control of the various systems described in this specification, or portions of them, can be implemented in a digital and/or quantum computer program product that includes instructions that are stored on one or more tangible, non-transitory machine-readable storage media, and that are executable on one or more digital and/or quantum processing devices. The systems described in this specification, or portions of them, can each be implemented as an apparatus, method, or electronic system that may include one or more digital and/or quantum processing devices and memory to store executable instructions to perform the operations described in this specification.

While this specification contains many specific implementation details, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable sub combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A quantum computing system comprising:
a first multi-state device that is characterized by a set of quantum states that are subdivided into a set of computational states and a set of non-computational states, wherein each pair quantum states of the set of quantum states is associated with a separate discretized frequency of a set of discretized frequencies;
a first tunable device with a first coupler frequency that is tunable, wherein when the first coupler frequency is tuned to a first frequency value that is in accordance with a first subset of the set of quantized frequencies, a first energy-transfer operation that transfers a first quantized amount of energy from the first multi-state device to the first tunable device such that the first multi-state device is prepared in a first computational state of the set of computational states is enabled;
a first energy-storage device with a first resonant frequency that is enabled to at least temporarily store input energy that is in accordance with the first resonant frequency, wherein when the first coupler frequency is tuned to a second frequency value that is in accordance with the first resonant frequency, a second energy-transfer operation transfers the first quantized amount of energy from the first tunable device to the first energy-storage device is initiated; and
a processor device that is configured to cause a performance of a set of energy-transfer operations that includes the first energy-transfer operation and the second energy-transfer operation.

2. The quantum computing system of claim 1, wherein when causing the performance of the set of energy-transfer operations, the processor device causes a performance of operations comprising:
tuning the first coupler frequency of the first tunable device to the first frequency value;
initiating the first energy-transfer operation; and
tuning the first coupler frequency of the first tunable device to the second frequency value to initiate the second energy-transfer operation.

3. The quantum computing system of claim 1, wherein the first multi-state device is a first qubit, the first tunable device is a first qubit coupler, and the first energy-storage device is a first resonator device.

4. The quantum computing system of claim 3, wherein the first frequency value is a first qubit frequency that is in accordance with a transition between two non-consecutive quantum states of the set of quantum states.

5. The quantum computing system of claim 4, wherein the first resonant frequency of the first resonator device is significantly greater than the first qubit frequency.

6. The quantum computing system of claim 5, wherein the first resonant frequency of the first resonator device is approximately 1 GHz greater than the first qubit frequency.

7. The quantum computing system of claim 3, wherein the first qubit is implemented by a first transmon qubit of the quantum computing system.

8. The quantum computing system of claim 1, wherein quantum computing system is employed to reset the first multi-state device to a ground state from a non-computational excited state.

9. The quantum computing system of claim 3, when the first coupler frequency of the first qubit coupler is tuned to a third frequency value, the first qubit coupler operates to couple the first qubit to a second qubit of the quantum computing system.

10. The quantum computing system of claim 9, wherein when the first qubit coupler operates to couple the first qubit to the second qubit, the first qubit coupler mediates quantum logic gates for the first qubit and the second qubit.

11. The quantum computing system of claim 2, wherein the first computational state of the of the set of computational states is a ground state of the first multi-state device such that the first energy-transfer operation resets the first multi-state device to its ground state.

12. The quantum computing system of claim 2, wherein tuning the first coupler frequency of the first tunable device is in response to performing a measurement of the first multi-state device via a measurement device of the quantum computing system.

13. The quantum computing system of claim 1, wherein the first energy-transfer operation is a quantum state swap operation between the first multi-state device and the first tunable device.

14. The quantum computing system of claim 1, wherein the first energy-transfer operation results in transitioning the first multi-state device from a non-computational state to a first computational state of the set of computational states.

15. The quantum computing system of claim 14, wherein the first computational state is an eigenstate of a measurement device of the quantum computing system.

16. The quantum computing system of claim 15, wherein the eigenstate of the measurement device is a ground state for the first multi-state device.

17. A method for operating a quantum computing system that includes a first multi-state, a first tunable device with a first coupler frequency that is tunable, and a first energy-storage device with a first resonant frequency, the method comprising:
tuning the first coupler frequency of the first tunable device to a first frequency value, wherein when the first coupler frequency is tuned to the first frequency value, a first energy-transfer operation between the first tunable device and the first multi-state device is enabled;
initiating the first energy-transfer operation, wherein the first energy-transfer operation transfers a first quantized amount of energy from the first multi-state device to the first tunable device such that the first multi-state device is prepared in a first quantum state of a set of quantum states that characterizes the first multi-state device; and
tuning the first coupler frequency of the first tunable device to a second frequency value that is in accordance with the first resonant frequency of the first energy-storage device, wherein when the first coupler frequency is tuned to the second frequency value, a second energy-transfer operation between the first tunable device and the first energy-storage device is enabled that transfers the first quantized amount of energy from the first tunable device to the first energy-storage device.

18. The method of claim 17, wherein the first multi-state device is a first qubit, the first tunable device is a first qubit coupler, the first energy-storage device is a first resonator device, the resonant frequency of the first resonator is greater than the first frequency value, and the first quantum state is a ground state of the first qubit.

19. One or more tangible non-transitory computer-readable media storing computer-readable instructions that when executed by one or more processors cause the one or more processors to perform operations for operating a quantum computing system that includes a first multi-state, a first tunable device with a first coupler frequency that is tunable, and a first energy-storage device with a first resonant frequency, the operations comprising:
tuning the first coupler frequency of the first tunable device to a first frequency value, wherein when the first coupler frequency is tuned to the first frequency value, a first energy-transfer operation between the first tunable device and the first multi-state device is enabled;
initiating the first energy-transfer operation, wherein the first energy-transfer operation transfers a first quantized amount of energy from the first multi-state device to the first tunable device such that the first multi-state device is prepared in a first quantum state of a set of quantum states that characterizes the first multi-state device; and
tuning the first coupler frequency of the first tunable device to a second frequency value that is in accordance with the first resonant frequency of the first energy-storage, wherein when the first coupler frequency is tuned to the second frequency value, a second energy-transfer operation between the first tunable device and the first energy-storage device is enabled that transfers the first quantized amount of energy from the first tunable device to the first energy-storage device.

20. The non-transitory computer-readable media of claim 19, wherein the first multi-state device is a first qubit, the first tunable device is a first qubit coupler, the first energy-storage device is a first resonator device, the resonant frequency of the first resonator is greater than the first frequency value, and the first quantum state is a ground state of the first qubit.
